(19) United States
(12) Patent Application Publication
(10) Pub. No.: US 2026/0302367 A1
(43) Pub. Date: Oct. 1, 2026

(54) SECONDARY BATTERY

(71) Applicant: SAMSUNG SDI CO., LTD., Yongin-si (KR)

(72) Inventor: Eon Woo PARK, Yongin-si (KR)

(21) Appl. No.: 19/298,545

(22) Filed: Aug. 13, 2025

(30) Foreign Application Priority Data
Mar. 26, 2025 (KR) 10-2025-0038796

(51) Int. Cl. H01M 10/0587; H01M 10/052; H01M 50/105

(52) U.S. Cl. CPC H01M 10/0587; H01M 10/052; H01M 50/105; H01M 2220/20

(57) ABSTRACT

The secondary battery includes a case accommodating an electrolyte and an electrode assembly, the electrode assembly comprises a first electrode, a second electrode, and a separator, the separator disposed between the first electrode and the second electrode, the first electrode, the second electrode, and the separator are wound in one direction to form an end where winding terminates, the electrode assembly further comprises an adhesive member, the adhesive member comprises a first adhesive member having adhesive force independent of reacting with the electrolyte, and a second adhesive member having adhesive force dependent of reacting with the electrolyte, the first adhesive member is disposed at the end, and the second adhesive member is spaced apart from the first adhesive member.

### CROSS-REFERENCE TO RELATED APPLICATION

The present application claims priority to and the benefit of Korean Patent Application No. 10-2025-0038796, filed on Mar. 26, 2025, in the Korean Intellectual Property Office, the entire disclosure of which is incorporated herein by reference.

### BACKGROUND

### 1. Field

Embodiments of the present disclosure relate to a secondary battery.

### 2. Description of Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

This Background section is for the general understanding of the background of the present disclosure, and therefore, it may contain information that does not constitute related (or prior) art.

### SUMMARY

Embodiments of the present disclosure provide a secondary battery having an improved lifespan.

Embodiments of the present disclosure provide a secondary battery including a case, and an electrolyte and an electrode assembly accommodated in the case, the electrode assembly comprises a first electrode, a second electrode, and a separator between the first electrode and the second electrode, the first electrode, the second electrode, and the separator are wound in one direction to form an end where the winding terminates, the electrode assembly comprises an adhesive member, the adhesive member comprises a first adhesive member having adhesive force regardless of reaction with the electrolyte, and a second adhesive member having adhesive force by reacting with the electrolyte, the first adhesive member is disposed at the end, and the second adhesive member is spaced apart from the first adhesive member.

Embodiments of the present disclosure provide a secondary battery comprising: a case accommodating an electrolyte and an electrode assembly, wherein the electrode assembly comprises a first electrode, a second electrode, and a separator, the separator disposed between the first electrode and the second electrode, wherein the first electrode, the second electrode, and the separator are wound in one direction to form an end where winding terminates, wherein the electrode assembly further comprises an adhesive member, wherein the adhesive member comprises a first adhesive member having an adhesive force independent of reacting with the electrolyte, and a second adhesive member having an adhesive force dependent of reacting with the electrolyte, wherein the first adhesive member is disposed at the end, and wherein the second adhesive member is spaced apart from the first adhesive member.

In some embodiments, the first adhesive member includes polyethylene terephthalate and the second adhesive member comprises an OPS film.

In some embodiments, the case comprises a first surface corresponding to a folding surface, a second surface facing the first surface, a third surface, and a fourth surface connecting the first surface and the second surface, a first sealing layer is disposed on the third surface and the fourth surface, a second sealing layer is disposed on the second surface, and the first adhesive member is closer to the second sealing layer than the second adhesive member.

In some embodiments, the second surface is a cut surface of the case.

Embodiments of the present disclosure provide a secondary battery including a case, and an electrolyte and an electrode assembly accommodated in the case, the electrode assembly comprises a first electrode, a second electrode, and a separator between the first electrode and the second electrode, the first electrode, the second electrode, and the separator are wound in one direction to form an end where the winding terminates, the electrode assembly comprises an adhesive member, the adhesive member comprises a first adhesive member having adhesive force regardless of a reaction with the electrolyte, and a second adhesive member having adhesive force by reacting with the electrolyte, at least one of the first adhesive member and the second adhesive member covers the end, and the first adhesive member is disposed above and below the second adhesive member.

Embodiments of the present disclosure provide a secondary battery comprising:
a case accommodating an electrolyte and an electrode assembly, wherein the electrode assembly comprises a first electrode, a second electrode, and a separator, the separator disposed between the first electrode and the second electrode, wherein the first electrode, the second electrode, and the separator are wound in one direction to form an end where winding terminates, wherein the electrode assembly further comprises an adhesive member, wherein the adhesive member comprises a first adhesive member having an adhesive force independent of reacting with the electrolyte, and a second adhesive member an having adhesive force dependent of reacting with the electrolyte, wherein the first adhesive member or the second adhesive member covers the end, and wherein the first adhesive member is disposed above and below the second adhesive member.

In some embodiments, both the first adhesive member and the second adhesive member cover the end.

In some embodiments, the widths of the first adhesive member and the second adhesive member are different.

In some embodiments, a width of the first adhesive member is different from a width of the second adhesive member.

In some embodiments, the width of the second adhesive member is less than the width of the first adhesive member.

In some embodiments, the first adhesive member and the second adhesive member are misaligned.

In some embodiments, the case comprises a first surface corresponding to a folding surface, a second surface facing the first surface, a third surface, and a fourth surface connecting the first surface and the second surface, a first sealing layer is disposed on the third surface and the fourth surface, a second sealing layer is disposed on the second surface, and an end of the first adhesive member is closer to the second sealing layer than an end of the second adhesive member.

In some embodiments, the second adhesive member covers the end and the first adhesive member is disposed on at least one edge of the second adhesive member.

In some embodiments, the first adhesive member surrounds the edge of the second adhesive member.

In some embodiments, the adhesive member comprises a first adhesive pattern and a second adhesive pattern, both of which covering the end, and the first adhesive pattern and the second adhesive pattern are spaced apart.

Embodiments of the present disclosure provide a secondary battery including a case, an electrolyte and an electrode assembly accommodated in the case; and a first electrode tab and a second electrode tab coupled with the electrode assembly, the electrode assembly comprises a first electrode, a second electrode, and a separator between the first electrode and the second electrode, the first electrode, the second electrode, and the separator are wound in one direction to form an end where the winding terminates, the electrode assembly comprises an adhesive member on the end, and the end is formed between the first electrode tab and the second electrode tab.

Embodiments of the present disclosure provide a secondary battery comprising: a case accommodating an electrolyte and an electrode assembly; and a first electrode tab and a second electrode tab, each of which is coupled with the electrode assembly, wherein the electrode assembly comprises a first electrode, a second electrode, and a separator, the separator disposed between the first electrode and the second electrode, wherein the first electrode, the second electrode, and the separator are wound in one direction to form an end where winding terminates, wherein the electrode assembly further comprises an adhesive member on the end, and wherein the end is disposed between the first electrode tab and the second electrode tab.

In some embodiments, the adhesive member comprises one surface contacting the electrode assembly and an other surface contacting the case, wherein a first adhesive film is disposed on the one surface, and a second adhesive film is disposed on the other surface.

In some embodiments, the first adhesive film has adhesive force regardless of reaction with the electrolyte, and the second adhesive film has adhesive force by reacting with the electrolyte.

In some embodiments, the first adhesive film has adhesive force independent of reacting with the electrolyte, and wherein the second adhesive film has adhesive force dependent of reacting with the electrolyte.

In some embodiments, the first adhesive film comprises polyethylene terephthalate and the second adhesive film comprises an OPS film.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings.

FIG. 1 shows a method for manufacturing a secondary battery according to embodiments of the present disclosure.

FIG. 2 shows a method for manufacturing a secondary battery according to embodiments of the present disclosure.

FIG. 3 shows a method for manufacturing a secondary battery according to embodiments of the present disclosure.

FIG. 4 shows a method for manufacturing a secondary battery according to embodiments of the present disclosure.

FIG. 5 shows the arrangement of an electrolyte and an adhesive member according to the direction of a secondary battery according to embodiments of the present disclosure.

FIG. 6 shows the arrangement of an electrolyte and an adhesive member according to the direction of a secondary battery according to embodiments of the present disclosure.

FIG. 7 shows the adhesive member of the electrode assembly according to embodiments of the present disclosure.

FIG. 8 shows the adhesive member of the electrode assembly according to embodiments of the present disclosure.

FIG. 9 shows the adhesive member of the electrode assembly according to embodiments of the present disclosure.

FIG. 10 shows the adhesive member of the electrode assembly according to embodiments of the present disclosure.

FIG. 11 shows the adhesive member of the electrode assembly according to embodiments of the present disclosure.

FIG. 12 shows the adhesive member of the electrode assembly according to embodiments of the present disclosure.

FIG. 13 shows the adhesive member of the electrode assembly according to embodiments of the present disclosure.

FIG. 14 shows the adhesive member of the electrode assembly according to embodiments of the present disclosure.

FIG. 15 shows the adhesive member of the electrode assembly according to embodiments of the present disclosure.

FIG. 16 shows the adhesive member of the electrode assembly according to embodiments of the present disclosure.

FIG. 17 shows the adhesive member of the electrode assembly according to embodiments of the present disclosure.

FIG. 18 shows the adhesive member of the electrode assembly according to embodiments of the present disclosure.

FIG. 19 is a perspective view showing a battery pack including battery modules according to embodiments of the present disclosure.

FIG. 20 is a perspective view showing a battery pack including battery modules according to embodiments of the present disclosure.

FIG. 21 is a perspective view showing a vehicle including battery packs according to embodiments of the present disclosure.

FIG. 22 is a side view showing a vehicle including battery packs according to embodiments of the present disclosure.

### DETAILED DESCRIPTION OF EXEMPLARY EMBODIMENTS

Embodiments of the present disclosure are described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

An electrode assembly and a secondary battery according to an embodiment is described with reference to the drawings. The secondary battery may have a cylindrical geometry, a prismatic geometry, a pouch geometry, or a coin geometry. The secondary battery described in the present disclosure refers to a pouch-type secondary battery but it is not limited thereto.

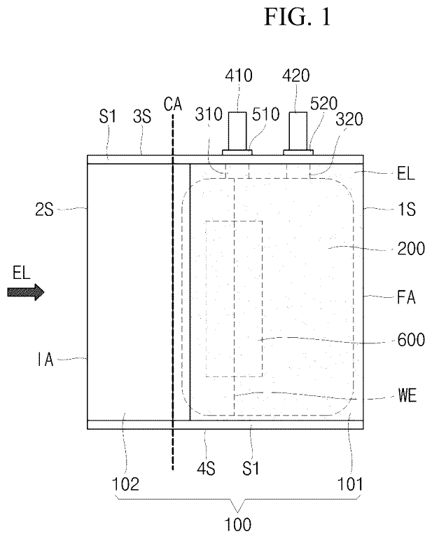

FIGS. 1 to 4 show a method for manufacturing a secondary battery 1000 according to an embodiment.

Referring to FIGS. 1 to 4, the secondary battery may include a case 100, an electrode assembly 200, an electrode tab 300, a lead 400, and an insulating layer 500.

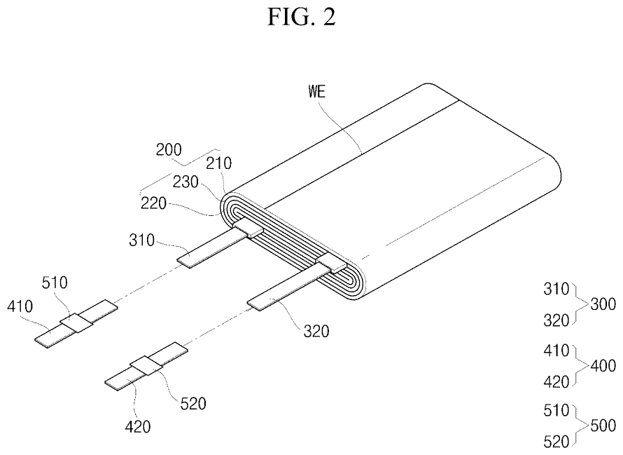

Referring to FIGS. 1 and 2, the case 100 may include an accommodating region 101 and a gas discharge region 102. The electrode assembly 200 may be disposed in the accommodating region 101. A boundary between the accommodating region 101 and the gas discharge region 102 may be defined as a cutting region CA. After the electrolyte is injected into the accommodating region 101, the case 100 may be cut along the cutting region CA.

The electrode assembly 200 may include a first electrode 210, a second electrode 220, and a separator 230. The electrode assembly 200 may be formed by winding the first electrode 210, the second electrode 220, and the separator 230. For example, the electrode assembly 200 may be formed by winding the first electrode 210, the second electrode 220, and the separator 230 in a jelly roll shape. Accordingly, the electrode assembly 200 may include an end WE where winding is terminated.

An adhesive member 600 may be disposed on the end WE. Accordingly, the end WE may be fixed by the adhesive member 600.

The first electrode 210 may include a first current collector and a first active material layer. The first current collector may include a metal foil such as aluminum or an aluminum alloy. The first active material layer may include a transition metal oxide. For example, the first electrode 210 may be a positive electrode.

The first electrode 210 may be connected to a first electrode tab 310. The first active material layer is not disposed on the first electrode tab 310. The first electrode tab 310 may be welded to the first current collector. The first electrode tab 310 may be integral with the first current collector. For example, the first current collector may include a first uncoated portion on which the first active material layer is not disposed. The first uncoated portion may be notched. In this manner, the first uncoated portion may be the first electrode tab 310. The first electrode tab 310 may include substantially the same material as the first current collector.

The second electrode 220 may include a second current collector and a second active material layer. The second current collector may include a metal foil such as copper, a copper alloy, nickel, or a nickel alloy. The second active material layer may include graphite or carbon. For example, the second electrode 220 may be a negative electrode.

The second electrode 220 may be connected to a second electrode tab 320. The second active material layer is not disposed on the second electrode tab 320. The second electrode tab 320 may be welded to the second current collector. The second electrode tab 320 may integral with the second current collector. For example, the second current collector may include a second uncoated portion on which the second active material layer is not disposed. The second uncoated portion may be notched. Accordingly, the second uncoated portion may be the second electrode tab 320. The second electrode tab 320 may include substantially the same material as the second current collector.

The separator 230 may prevent a short circuit between the first electrode 210 and the second electrode 220 while allowing the movement of lithium ions. The separator 230 may include a polyethylene film, a polypropylene film, or a polyethylene-polypropylene film.

The first electrode tab 310 and the second electrode tab 320 may each be connected to a lead. For example, the first electrode tab 310 may be connected to a first lead 410. The first electrode tab 310 may be connected to the first external terminal by the first lead 410. The second electrode tab 320 may be connected to a second lead 420. The second electrode tab 320 may be connected to the second external terminal by the second lead 420. The first lead 410 may include substantially the same material as the first electrode tab. The second lead 420 may include substantially the same material as the second electrode tab.

The insulating layer 500 may be disposed on the lead. The insulating layer may be disposed on a portion of the lead. The insulating layer may be disposed to surround the lead. For example, a first insulating layer 510 may be disposed on the first lead 410. A second insulating layer 520 may be disposed on the second lead 420. The lead 400 may be insulated from the case 100 by the insulating layer 500.

After the electrode assembly 200 is disposed in the accommodating region 101, the case 100 may be folded. The case 100 may be folded corresponding to the folding region FA. Accordingly, a first surface 1S, a second surface 2S, a third surface 3S, and a fourth surface 4S may be formed in the case 100.

The first surface 1S may be a folding surface. The second surface 2S may be a surface facing the first surface 1S. The third surface 3S and the fourth surface 4S may be surfaces connecting the first surface 1S and the second surface 2S. The third surface 3S and the fourth surface 4S may face each other.

Before the case 100 is folded, a first sealing layer S1 is disposed on the third surface 3S and the fourth surface 4S. Accordingly, after the case 100 is folded, the folding of the case may be maintained.

The sealing layer is not disposed on the second surface 2S. Accordingly, the second surface 2S may be the injection region IA. The electrolyte EL is injected into the accommodating region 101 through the injection region IA.

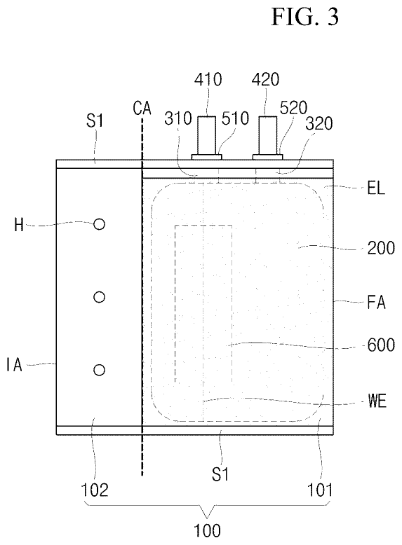

Referring to FIG. 3, after the electrolyte EL is injected, a degassing process is performed. A hole H may be formed in the gas discharge region 102. At least one hole H may be formed in the gas discharge region 102.

When the electrolyte is injected, gas or air may be introduced into the in the case 100. Accordingly, the internal pressure of the case may increase. The air is discharged to the outside of the case through the hole H. Accordingly, an increase of internal pressure of the case may be prevented.

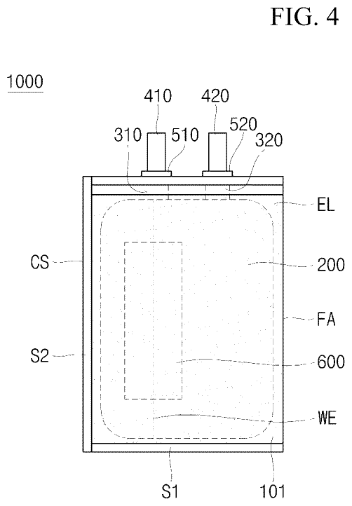

Referring to FIG. 4, the gas discharge region 102 may be cut. The gas discharge region 102 may be cut along the cutting region CA (see FIG. 1). Next, a cut surface CS may be sealed. By the cutting, the cut surface may be the second surface of the case. The cut surface CS may be sealed by the second sealing layer S2.

Accordingly, the secondary battery may be manufactured.

An external impact may be transmitted to the secondary battery. Accordingly, the electrode assembly 200 may be dislocated within the case.

In the prior art, an adhesive material including a double-sided tape was used to prevent movement of the electrode assembly due to external impact. The double-sided tape includes one surface and an opposite surface to the one surface. A first adhesive film is disposed on the one surface, and a second adhesive film is disposed on the opposite surface. The first adhesive film covers the end WE. Accordingly, the end WE is fixed by the first adhesive film. The second adhesive film contacts the case. The second adhesive film includes an oriented polystyrene (OPS) film. Accordingly, the electrode assembly is adhered to the case. Therefore, the electrode assembly may be prevented from moving in the case due to external impact.

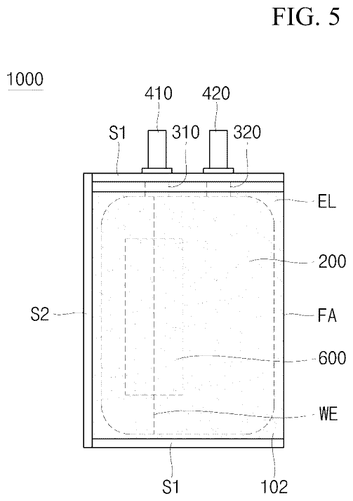

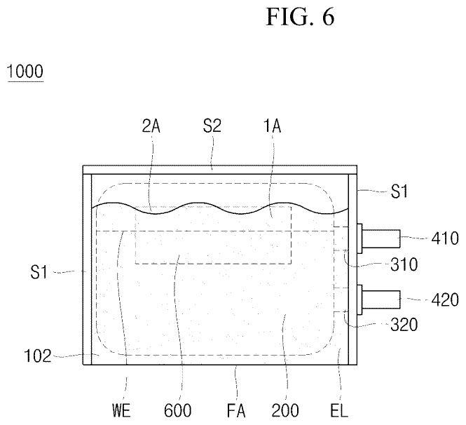

Referring to FIGS. 5 and 6, after manufacturing the secondary battery 1000, the secondary battery may be stored. A region in which the OPS film is not impregnated with an electrolyte may be formed along to the loading direction of the secondary battery 1000.

Referring to FIG. 5, the OPS film is completely impregnated with the electrolyte EL. However, referring to FIG. 6, a region where the OPS film is not impregnated with the electrolyte EL may be formed. Accordingly, the second adhesive film may be divided into a first region 1A and a second region 2A. The first region 1A is a region impregnated with the electrolyte EL, and the second region 2A is a region not impregnated with the electrolyte EL. The OPS film has adhesive force when reacting with electrolyte. Therefore, the first region 1A has adhesive force, and the second region 2A does not have adhesive force.

Accordingly, a difference in surface tension may occur in the first region 1A and the second region 2A. As a result, the OPS film may shrink.

Accordingly, shrinkage of the OPS film may be recognized from the exterior of the case. As a result, the appearance of the secondary battery may be defective. The adhesive strength of the OPS film may decrease. As a result, the second adhesive film and the case may be separated. As a result, the secondary battery may be dislocated within the case due to external impact. As a result, the performance and lifespan of the secondary battery may decrease.

The electrode assembly according to embodiments of the present disclosure may solve such problems by controlling the position and/or material of the adhesive member.

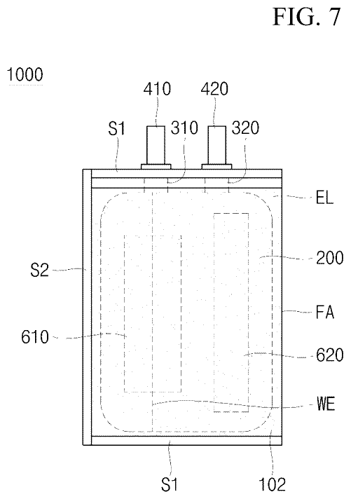

FIGS. 7 to 18 show adhesive members.

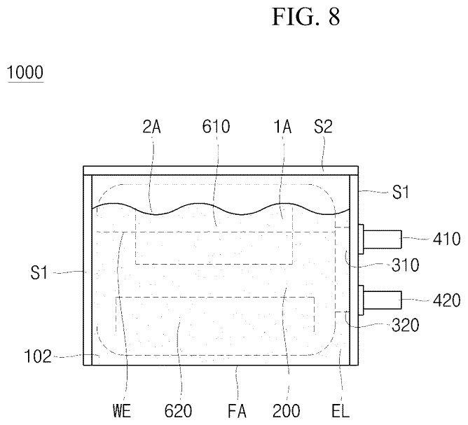

Referring to FIGS. 7 and 8, the adhesive member 600 may include a first adhesive member 610 and a second adhesive member 620.

The first adhesive member 610 and the second adhesive member 620 may be positioned at different locations. The first adhesive member 610 and the second adhesive member 620 do not overlap.

The first adhesive member 610 may be adjacent to the second sealing layer S2. The first adhesive member 610 may be closer to the second sealing layer S2 than the second adhesive member 620. That is, the first adhesive member 610 may be closer to the injection region IA than the second adhesive member 620.

The first adhesive member 610 and the second adhesive member 620 may include different materials. For example, the first adhesive member 610 may include polyethylene terephthalate (PET), and the second adhesive member 620 may include an OPS film.

The OPS film does not typically have satisfactory adhesive force. The OPS film has adhesive force when it reacts with dimethyl carbonate (DMC) that may be included in the electrolyte. The OPS film is a solid-state film and generally does not have adhesive force. However, without being bound by any particular theory, when the OPS film reacts with DMC, the DMC penetrates into the pores of the polymer chains, so that the polymer chains become a fluid state in which they are easy to move and have adhesive force. That is, the OPS film reacts with DMC to change the phase from a solid state to a viscous liquid state, and through this process, it may have adhesive force.

Therefore, the first adhesive member 610 and the second adhesive member 620 may have different adhesive characteristics. The first adhesive member 610 always has adhesive force regardless of the reaction with the electrolyte. On the other hand, the second adhesive member 620 has adhesive force when reacting with the electrolyte.

The first adhesive member 610 may have adhesive force regardless of the reaction with the electrolyte. Accordingly, even if the first adhesive member 610 is not completely impregnated with the electrolyte EL, the adhesive force of the first adhesive member 610 is maintained. Therefore, unwinding of the end WE can be prevented.

Referring to FIGS. 7 and 8, the first adhesive member 610 may include a region that is not impregnated with the electrolyte EL depending on the loading direction of the secondary battery. However, the first adhesive member 610 has adhesive force regardless of whether or not the electrolyte EL is impregnated. Accordingly, even if the loading direction of the secondary battery changes, unwinding of the end WE may be prevented.

The second adhesive member 620 has adhesive force when reacting with the electrolyte. The second adhesive member 620 is disposed in a region distant from the second sealing layer S2. Accordingly, the second adhesive member not being impregnated into the electrolyte may be prevented. Accordingly, the electrode assembly may be prevented from being dislocated within the case due to external impact.

Referring to FIGS. 7 and 8, the second adhesive member 620 does not form a region that is not impregnated with the electrolyte EL even if the loading direction of the secondary battery changes. Therefore, the formation of a region that is not impregnated with the electrolyte may be prevented in the second adhesive member 620. Accordingly, even if the loading direction of the secondary battery changes, the adhesive force of the second adhesive member 620 may be maintained.

Therefore, the secondary battery according to the embodiment may have improved performance and lifespan.

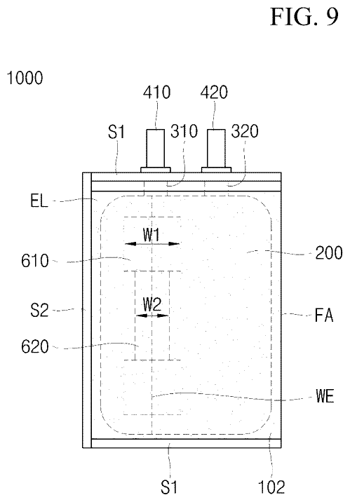

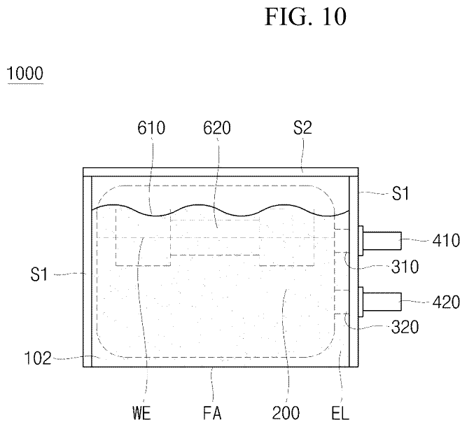

Referring to FIGS. 9 and 10, the adhesive member 600 may include the first adhesive member 610 and the second adhesive member 620.

The first adhesive member 610 and the second adhesive member 620 may be disposed along the same line. The first adhesive member 610 and the second adhesive member 620 may be disposed to cover the end WE. The first adhesive member 610 may be disposed above and below the second adhesive member 620.

The first adhesive member 610 and the second adhesive member 620 may include different materials. For example, the first adhesive member 610 may include polyethylene terephthalate (PET), and the second adhesive member 620 may include the OPS film.

The first adhesive member 610 and the second adhesive member 620 may have different sizes. For example, the first adhesive member 610 and the second adhesive member 620 may have different widths. For example, a width W1 of the first adhesive member may be greater than a width W2 of the second adhesive member. Accordingly, an end of the first adhesive member 610 may be closer to the second sealing layer S2 than an end of the second adhesive member 620. That is, the end of the first adhesive member 610 may be closer to the injection region IA than the end of the second adhesive member 620.

Both the first adhesive member 610 and the second adhesive member 620 may be disposed at the end WE. Accordingly, the fixing force of the end WE is improved, so that unwinding of the electrode assembly may be prevented.

The second adhesive member 620 has a width less than the first adhesive member 610. Accordingly, it may be prevented that the second adhesive member is not impregnated into the electrolyte. Accordingly, the electrode assembly may be prevented from being dislocated within the case due to external impact.

Referring to FIGS. 9 and 10, the first adhesive member 610 may form a region that is not impregnated with the electrolyte EL when the loading direction of the secondary battery changes. However, the first adhesive member 610 has adhesive force regardless of the reaction with the electrolyte. Therefore, the adhesive force of the first adhesive member 610 is maintained.

On the other hand, the second adhesive member 620 does not form a region that is not impregnated with the electrolyte EL even when the loading direction of the secondary battery changes. Because the width of the second adhesive member 620 is controlled, it is possible to prevent the formation of a region that is not impregnated with the electrolyte in the second adhesive member 620. Accordingly, the adhesive force of the second adhesive member 620 may be maintained even when the loading direction of the secondary battery changes.

Therefore, the secondary battery according to the embodiment can have improved performance and lifespan.

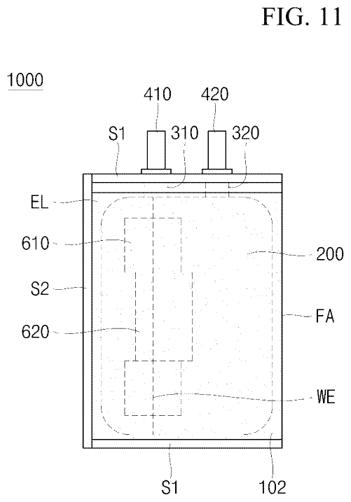

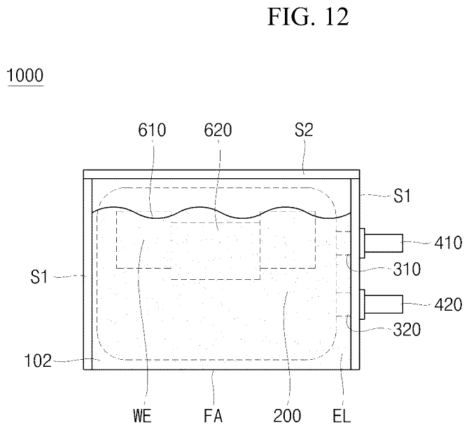

Referring to FIGS. 11 and 12, the adhesive member 600 may include the first adhesive member 610 and the second adhesive member 620.

The first adhesive member 610 and the second adhesive member 620 may be disposed to cover the end WE. The first adhesive member 610 may be disposed above and below the second adhesive member 620. The first adhesive member 610 and the second adhesive member 620 may have substantially the same or similar sizes. For example, the first adhesive member 610 and the second adhesive member 620 may have substantially the same or similar widths.

The first adhesive member 610 and the second adhesive member 620 may be misaligned. The first adhesive member 610 may be closer to the second sealing layer S2 than the second adhesive member 620. That is, the first adhesive member 610 may be closer to the injection region IA than the second adhesive member 620.

The first adhesive member 610 and the second adhesive member 620 may include different materials. For example, the first adhesive member 610 may include polyethylene terephthalate (PET), and the second adhesive member 620 may include the OPS film.

Both the first adhesive member 610 and the second adhesive member 620 may be disposed at the end WE. Accordingly, the fixing force of the end WE is improved, thereby preventing the electrode assembly from being unwound.

The second adhesive member 620 is positioned further from the second sealing layer 2S than the first adhesive member 610. Accordingly, it may be prevented that the second adhesive member is not impregnated into the electrolyte. Accordingly, the electrode assembly may be prevented from moving in the case due to external impact.

Referring to FIGS. 11 and 12, the first adhesive member 610 may form a region that is not impregnated with the electrolyte EL when the loading direction of the secondary battery changes. However, the first adhesive member 610 has adhesive force regardless of the reaction with the electrolyte. Therefore, the adhesive force of the first adhesive member 610 is maintained.

On the other hand, the second adhesive member 620 does not form a region that is not impregnated with the electrolyte EL even when the loading direction of the secondary battery changes. Because the position of the second adhesive member 620 is controlled, it is possible to prevent the formation of a region that is not impregnated with the electrolyte in the second adhesive member 620. Accordingly, the adhesive force of the second adhesive member 620 may be maintained even when the loading direction of the secondary battery changes.

Therefore, the secondary battery according to the embodiment can have improved performance and lifespan.

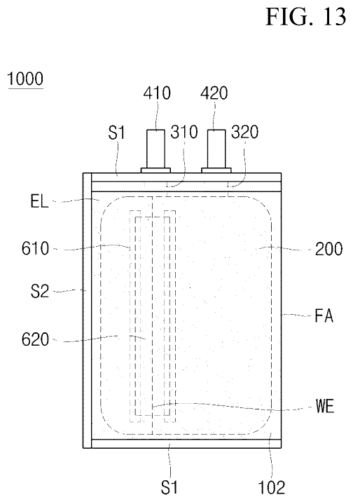

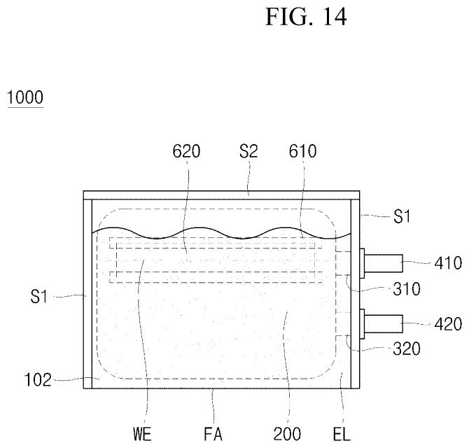

Referring to FIGS. 13 and 14, the adhesive member 600 may include the first adhesive member 610 and the second adhesive member 620.

The first adhesive member 610 and the second adhesive member 620 may include different materials. For example, the first adhesive member 610 may include polyethylene terephthalate (PET), and the second adhesive member 620 may include the OPS film.

The second adhesive member 620 may be disposed to cover the end WE. The first adhesive member 610 does not cover the end WE. The first adhesive member 610 may be disposed along the edge of the second adhesive member. The first adhesive member 610 may be disposed along at least one edge of the second adhesive member.

The second adhesive member 620 may be disposed at the end WE. The first adhesive member 610 may be disposed at the edge of the second adhesive member. Accordingly, the edge of the second adhesive member is fixed by the first adhesive member 610. Therefore, the adhesive strength of the second adhesive member may be improved.

It may be prevented that the second adhesive member is not impregnated into the electrolyte. Accordingly, the electrode assembly may be prevented from being dislocated within the case due to external impact.

Referring to FIGS. 13 and 14, the second adhesive member 620 may form a region that is not impregnated with the electrolyte EL when the loading direction of the secondary battery changes. However, the first adhesive member 610 may be disposed at the edge of the second adhesive member 620. The first adhesive member 610 has adhesive force regardless of the reaction with the electrolyte. Therefore, the adhesive force of the first adhesive member 610 is maintained. Accordingly, the region where the second adhesive member 620 is not impregnated with the electrolyte may be fixed by the first adhesive member 610. Accordingly, the second adhesive member 620 may be prevented from shrinking. Accordingly, the second adhesive member 620 may be prevented from shrinking depending on the loading direction of the secondary battery.

Accordingly, the secondary battery according to the embodiment can have improved performance and lifespan.

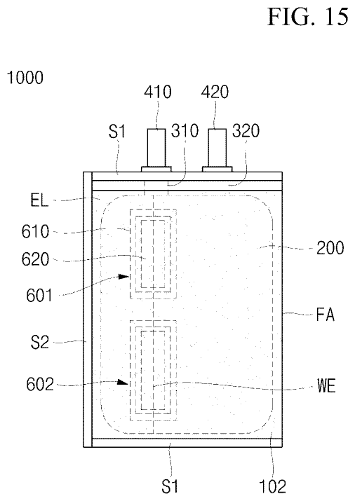

Referring to FIGS. 15 16, the adhesive member 600 may include the first adhesive member 610 and the second adhesive member 620.

The first adhesive member 610 and the second adhesive member 620 may include different materials. For example, the first adhesive member 610 may include polyethylene terephthalate (PET), and the second adhesive member 620 may include the OPS film.

The adhesive member 600 may include a plurality of adhesive patterns. For example, the adhesive member 600 may include at least two adhesive patterns. For example, the adhesive member 600 may include a first adhesive pattern 601 and a second adhesive pattern 602. The first adhesive pattern 601 and the second adhesive pattern 602 may be spaced apart from each other.

The first adhesive pattern 601 and the second adhesive pattern 602 may be disposed to cover the end WE. The first adhesive member 610 does not cover the end WE. The first adhesive member 610 may be disposed along the edge of the second adhesive member. The first adhesive member 610 may be disposed along at least one edge of the second adhesive member.

The second adhesive member 620 may be disposed at the end WE. The first adhesive member 610 may be disposed at the edge of the second adhesive member. Accordingly, the edge of the second adhesive member is fixed by the first adhesive member 610. Therefore, the adhesive strength of the second adhesive member may be improved.

It may be prevented that the second adhesive member is not impregnated into the electrolyte. Accordingly, the electrode assembly may be prevented from moving in the case due to external impact.

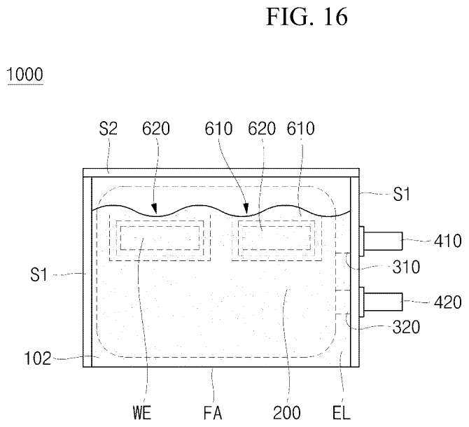

Referring to FIGS. 15 and 16, the second adhesive member 620 may form a region that is not impregnated with the electrolyte EL when the loading direction of the secondary battery changes. However, the first adhesive member 610 may be disposed at the edge of the second adhesive member 620. The first adhesive member 610 has adhesive force regardless of the reaction with the electrolyte. Therefore, the adhesive force of the first adhesive member 610 is maintained. Accordingly, the region where the second adhesive member 620 is not impregnated with the electrolyte may be fixed by the first adhesive member 610. Accordingly, the second adhesive member 620 may be prevented from shrinking. Accordingly, the second adhesive member 620 may be prevented from shrinking depending on the loading direction of the secondary battery.

The adhesive member may include a plurality of adhesive patterns. Accordingly, even if a defect occurs in any one of the adhesive patterns, unwinding of the end may be prevented. Even if a defect occurs in any one of the adhesive patterns, the electrode assembly may be prevented from being dislocated within the case.

Therefore, the secondary battery according to the embodiment may have improved performance and lifespan.

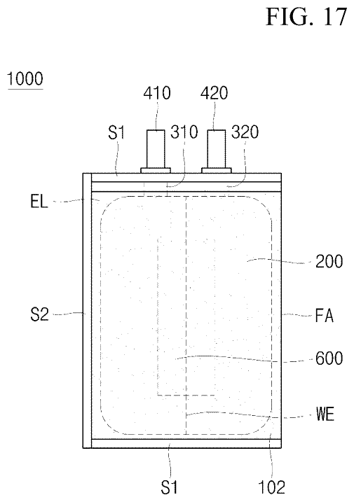

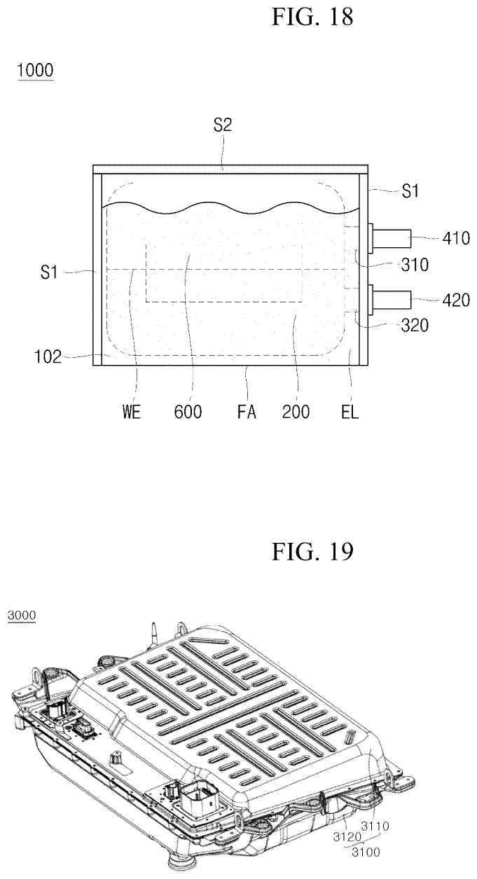

Referring to FIGS. 17 and 18, the electrode assembly 200 may include the adhesive member 600. The electrode assembly 200 may include the end WE at which winding is terminated. The adhesive member 600 is disposed to cover the end WE.

The adhesive member 600 may include a double-sided adhesive member. For example, the adhesive member 600 may include one surface and the other surface. The one surface contacts the electrode assembly 200. The other surface contacts the case. A first adhesive film is disposed on the one surface. A second adhesive film is disposed on the other surface. Accordingly, the end WE may be fixed by the first adhesive film. The electrode assembly may be fixed within the case by the second adhesive film.

The first adhesive film may include polyethylene terephthalate (PET) and the second adhesive film may include OPS film.

The end WE may be disposed at a set position. The end WE may be disposed between the first electrode tab 310 and the second electrode tab 320.

Accordingly, it may be prevented that the second adhesive member is not impregnated into the electrolyte. Accordingly, the electrode assembly may be prevented from moving in the case due to external impact.

Referring to FIGS. 17 and 18, the electrolyte EL may be changed according to the loading direction of the secondary battery. The end WE is disposed between the first electrode tab 310 and the second electrode tab 320. Accordingly, it may be prevented that the adhesive member is not impregnated into the electrolyte by the movement of the electrolyte EL. Accordingly, the second adhesive film may be prevented from shrinking. And, the adhesive member and the case may be prevented from being separated.

Accordingly, the secondary battery according to the embodiment may have improved performance and lifespan.

The electrode assembly according to the embodiment includes an adhesive member. The adhesive member includes the first adhesive member and the second adhesive member containing different materials.

The first adhesive member and the second adhesive member are disposed at a set position. The end where the winding of the electrode assembly terminates is disposed at a set position. Accordingly, the adhesive force of the adhesive member may be prevented from being reduced due to movement of the electrolyte according to the loading direction of the secondary battery. The adhesive member can be prevented from being shrunk.

Accordingly, unwinding of the electrode assembly may be prevented. The electrode assembly may be prevented from being moved in the case due to the external impact.

Therefore, the electrode assembly according to the embodiment and the secondary battery including the same may have improved performance and lifespan.

The secondary battery may be used in portable small electronic devices such as smartphones, feature phones, notebook computers, digital cameras, and camcorders. A battery module and a battery pack including a plurality of secondary batteries may be used as a power source for driving a motor of a hybrid vehicle or an electric vehicle and as a battery for storing power.

The secondary battery described above may form a battery module. For example, the battery module may include a plurality of secondary batteries. The plurality of secondary batteries may be connected to each other in series, parallel, or series/parallel by a bus bar.

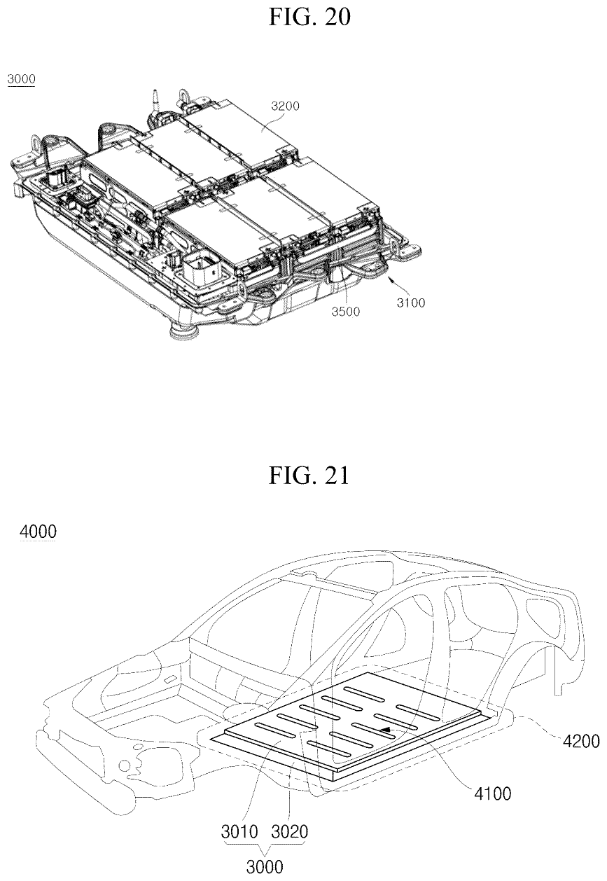

FIGS. 19 and 20 show a battery pack 3000. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. For convenience of illustration, parts such as bus bars, cooling units, and external terminals for electrical connection of secondary battery are omitted. In some embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

Referring to FIG. 21, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle.

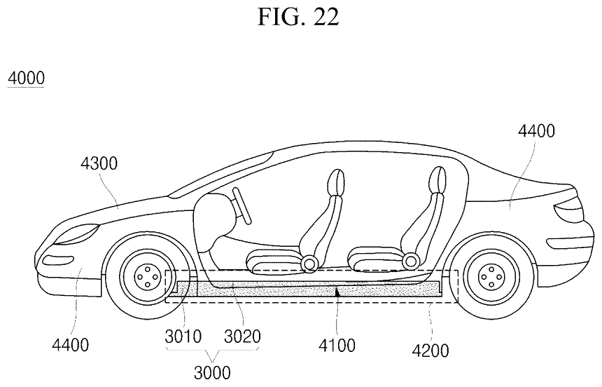

Referring to FIG. 22, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A secondary battery comprising:
a case accommodating an electrolyte and an electrode assembly,
wherein the electrode assembly comprises a first electrode, a second electrode, and a separator, the separator disposed between the first electrode and the second electrode,
wherein the first electrode, the second electrode, and the separator are wound in one direction to form an end where winding terminates,
wherein the electrode assembly further comprises an adhesive member,
wherein the adhesive member comprises a first adhesive member having an adhesive force independent of reacting with the electrolyte, and a second adhesive member having an adhesive force dependent of reacting with the electrolyte,
wherein the first adhesive member is disposed at the end, and
wherein the second adhesive member is spaced apart from the first adhesive member.

2. The secondary battery as claimed in claim 1, wherein the first adhesive member comprises polyethylene terephthalate and the second adhesive member comprises an oriented polystyrene film.

3. The secondary battery as claimed in claim 1, wherein the case comprises a first surface corresponding to a folding surface, a second surface facing the first surface, a third surface, and a fourth surface connecting the first surface and the second surface, wherein a first sealing layer is disposed on the third surface and the fourth surface, wherein a second sealing layer is disposed on the second surface, and wherein the first adhesive member is closer to the second sealing layer than the second adhesive member.

4. The secondary battery as claimed in claim 3, wherein the second surface is a cut surface of the case.

5. A secondary battery comprising:
a case accommodating an electrolyte and an electrode assembly,
wherein the electrode assembly comprises a first electrode, a second electrode, and a separator, the separator disposed between the first electrode and the second electrode,
wherein the first electrode, the second electrode, and the separator are wound in one direction to form an end where winding terminates,
wherein the electrode assembly further comprises an adhesive member,
wherein the adhesive member comprises a first adhesive member having an adhesive force independent of reacting with the electrolyte, and a second adhesive member an having adhesive force dependent of reacting with the electrolyte,
wherein the first adhesive member or the second adhesive member covers the end, and
wherein the first adhesive member is disposed above and below the second adhesive member.

6. The secondary battery as claimed in claim 5, wherein both the first adhesive member and the second adhesive member cover the end.

7. The secondary battery as claimed in claim 6, wherein a width of the first adhesive member is different from a width of the second adhesive member.

8. The secondary battery as claimed in claim 6, wherein the width of the second adhesive member is less than the width of the first adhesive member.

9. The secondary battery as claimed in claim 6, wherein the first adhesive member and the second adhesive member are misaligned.

10. The secondary battery as claimed in claim 6, wherein the case comprises a first surface corresponding to a folding surface, a second surface facing the first surface, a third surface, and a fourth surface connecting the first surface and the second surface, wherein a first sealing layer is disposed on the third surface and the fourth surface, wherein a second sealing layer is disposed on the second surface, and wherein an end of the first adhesive member is closer to the second sealing layer than an end of the second adhesive member.

11. The secondary battery as claimed in claim 5, wherein the second adhesive member covers the end and the first adhesive member is disposed on at least one edge of the second adhesive member.

12. The secondary battery as claimed in claim 11, wherein the first adhesive member surrounds the edge of the second adhesive member.

13. The secondary battery as claimed in claim 11, wherein the case comprises a first surface corresponding to a folding surface, a second surface facing the first surface, a third surface, and a fourth surface connecting the first surface and the second surface, wherein a first sealing layer is disposed on the third surface and the fourth surface, wherein a second sealing layer is disposed on the second surface, and wherein an end of the first adhesive member is closer to the second sealing layer than an end of the second adhesive member.

14. The secondary battery as claimed in claim 11, wherein the adhesive member comprises a first adhesive pattern and a second adhesive pattern, both of which covering the end, and wherein the first adhesive pattern and the second adhesive pattern are spaced apart.

15. A secondary battery comprising:
a case accommodating an electrolyte and an electrode assembly; and
a first electrode tab and a second electrode tab, each of which is coupled with the electrode assembly,
wherein the electrode assembly comprises a first electrode, a second electrode, and a separator, the separator disposed between the first electrode and the second electrode,
wherein the first electrode, the second electrode, and the separator are wound in one direction to form an end where winding terminates,
wherein the electrode assembly further comprises an adhesive member on the end, and
wherein the end is disposed between the first electrode tab and the second electrode tab.

16. The secondary battery as claimed in claim 15, wherein the adhesive member comprises one surface contacting the electrode assembly and an other surface contacting the case, wherein a first adhesive film is disposed on the one surface, and wherein a second adhesive film is disposed on the other surface.

17. The secondary battery as claimed in claim 16, wherein the first adhesive film has adhesive force independent of reacting with the electrolyte, and wherein the second adhesive film has adhesive force dependent of reacting with the electrolyte.

18. The secondary battery as claimed in claim 16, wherein the first adhesive film comprises polyethylene terephthalate and the second adhesive film comprises an oriented polystyrene film.
